(19) United States
(12) Patent Application Publication
(10) Pub. No.: US 2026/0090574 A1
(43) Pub. Date: Apr. 2, 2026

(54) YOUNG BARLEY LEAF POWDER, METHOD FOR PRODUCING SAME, AND ORAL COMPOSITION

(71) Applicant: TOYO SHINYAKU CO., LTD., Fukuoka (JP)

(72) Inventors: Hiroya TAKAHASHI, Saga (JP); Yoshifumi KOSEKI, Saga (JP)

(73) Assignee: TOYO SHINYAKU CO., LTD., Fukuoka (JP)

(21) Appl. No.: 18/898,685

(22) Filed: Sep. 27, 2024

(51) Int. Cl. A23L 7/10; A23L 5/10

(52) U.S. Cl. CPC A23L 7/198; A23L 5/13

(57) ABSTRACT

A young barley leaf powder and a method for producing the same are provided. By processing young barley leaves from harvesting to powdering in an extremely short time, young barley leaf powder presenting a vivid green color can be obtained.

### BACKGROUND

The invention relates to a young barley leaf powder presenting a vivid green color and a method for producing the same.

### DESCRIPTION OF RELATED ART

Young barley leaves are known to possess various functions, such as blood pressure lowering effects (Patent Document 1). In addition, with the abundant nutritional components, young barley leaves are used as raw materials for health foods. Since young barley leaves are green, such leaves are often used in green smoothies by utilizing such property. However, in general, young barley leaves exhibit a weak and dark tone of green and thus do not facilitate people's appetite. Therefore, despite having various functionalities and abundant nutrition components, not many consumers intake young barley leaves on a daily basis. In view of the above, the development of young barley leaves presenting a vivid green color (deep and bright green) preferred by people has been sought.

### PRIOR ART DOCUMENT(S)

### Patent Document(s)

[Patent Document 1] Japanese Patent Application Laid-open No. S59-116226

### SUMMARY

### Issues to be Solved by the Invention

The invention has been made in view of the above issues and aims to provide a young barley leaf powder presenting a vivid green color and a method for producing the same.

### Means for Solving the Issues

As a result of extensive research, the inventors found that by processing young barley leaves from harvesting to powdering in an extremely short time, young barley leaf powder presenting a vivid green color can be obtained, thus completing the invention.

### That is, the Invention is Related to the Following.

[1] A young barley leaf powder is provided. For the young barley leaf powder, in a CIE L*a*b* color system, a value of a* is −2 or less, and a value of L* is 50 or more.
[2] A method for producing the young barley leaf powder according to [1] includes:
   (1) a process of harvesting young barley leaves;
   (2) a process of performing a blanching process on the young barley leaves that are harvested with hot water;
   (3) a process of drying the young barley leaves on which the blanching process is performed; and
   (4) a process of grinding the young barley leaves that are dried, the processes from (1) to (4) being performed within 24 hours.
[3] An oral composition contains the young barley leaf powder according to [1].
[4] A powdered beverage contains the young barley leaf powder according to [1].
[5] In the young barley leaf powder according to [1], the value of a* is −5 or less.
[6] In the young barley leaf powder according to [1], the value of a* is −20 or more.
[7] In the young barley leaf powder according to [1], the value of L* is 55 or more.
[8] In the young barley leaf powder according to [1], the value of L* is 80 or less.
[9] In the young barley leaf powder according to [1], the young barley leaf powder is ground powder of young barley leaves.

### Inventive Effects

According to the invention, by processing young barley leaves from harvesting to powdering within an extremely short time, young barley leaf powder presenting a vivid green color can be obtained.

### DESCRIPTION OF THE EMBODIMENTS

The invention will be described in detail below.

### [A. Young Barley Leaf Powder]

Barley (Hordeum vulgare L.) originates from central Asia and is an annual or biennial herbaceous plant belonging to the Poaceae family. The plant variety of barley used in the invention is not particularly limited. Any plant variety of barley can be used, including wild species or hybrids.

The young barley leaves in the invention refer to plant bodies including leaf portions of the barley, and may include stems or other portions together with leaves. From the viewpoint of exhibiting a more pronounced intestinal regulation effect, it is preferable to include only leaves, or leaves along with stems.

The young barley leaf powder in the invention refers to young barley leaves that have been powdered. As the young barley leaf powder of the invention, examples may include the ground powder of young barley leaves, the dry powder of the juice of young barley leaves, the dry powder of young barley leaf extract, but the ground powder of young barley leaves is preferred for including abundant insoluble dietary fiber that is a nutrition component.

### [B. Method for Producing Young Barley Leaf Powder]

According to the invention, in the production of young barley leaf powder, by performing: (1) a harvesting process, (2) a blanching process, (3) a drying process, and (4) a grinding process within 24 hours, a young barley leaf powder presenting a vivid green color can be obtained. Performing the processes from (1) harvesting to (4) grinding within 24 hours means that the time required from harvesting young barley leaves to completing the grinding process is within 24 hours.

To produce young barley leaf powder, it is necessary to harvest young barley leaves in the field and then transport the leaves to a factory for processing. Conventionally, the period from harvesting young barley leaves to processing the leaves into powder generally lasts for from several days to about one week. The reasons are as follows: (A) the distance between the field and the factory is usually far, and it takes time to transport the young barley leaves; (B) to reduce the production cost, it is common to stock young barley leaves in the factory until a certain amount is secured and then process the stocked leaves together for better production efficiency; (C) the producers of young barley leaves and the processors who perform the powdering process at the factory are usually separate, and it takes time for transaction and quality confirmation acceptance inspection; and (D) as the harvested young barley leaves do not spoil immediately, there is no need to process the leaves in a hurry, etc. Therefore, based on conventional technical knowledge, there is no motivation to shorten the time from harvesting young barley leaves to processing the leaves into powder. However, the inventors of the invention found that by making the period from harvesting young barley leaves to processing the leaves into powder extremely short, specifically within 24 hours, the obtained young barley leaf powder may, unexpectedly, present a vivid green color. Accordingly, the invention is completed.

### (1) Harvesting Process

The young barley leaves may be harvested at any time, and the harvest time is not particularly limited. However, from the viewpoint of exhibiting a more pronounced intestinal regulation effect, it is preferable to use young barley leaves harvested before the maturity stage, namely, leaves harvested from the start of tillering to the early stage when heading begins. Specifically, it is preferable to use young barley leaves harvested from barley with a height of 10 cm or more, preferably about 10 cm to 90 cm, more preferably about 20 cm to 80 cm, and particularly about 30 cm to 70 cm.

### (2) Blanching Process

In the production method of the invention, after the young barley leaves are harvested, the blanching process is performed before the drying process. Examples of the blanching process may include a hot water process or a steaming process.

As the hot water process, examples may include a method of treating the young barley leaves in hot water or steam at 70° C. to 100° C., preferably 80° C. to 100° C., for 60 seconds to 240 seconds, preferably 90 seconds to 180 seconds.

As the steaming process, examples may include an intermittent steaming process, in which a process of steaming young barley leaves with steam and a process of cooling are repeated under a normal pressure or pressurized condition. In the intermittent steaming process, the steaming process is performed with water vapor, for example, for 20-40 seconds, preferably for 30 seconds. The cooling process after the steaming process is preferably performed immediately, and the method is not particularly limited.

### (3) Drying Process

The drying process is not particularly limited. However, examples may include a process of drying the young barley leaves so that the moisture content becomes 10% by weight or less, preferably 8% by weight or less. The drying process can be performed by any method known to those skilled in the art, such as hot air drying, high-pressure steam drying, electromagnetic wave drying, freeze-drying, etc. In the drying process, the young barley leaves can be dried by using any equipment or apparatus commonly used by those skilled in the art, such as a constant temperature dryer.

### (4) Grinding Process

The grinding process is not particularly limited. However, examples may include a process of grinding the plant body by adopting any method commonly adopted by those skilled in the art. In the grinding process, it is preferable to combine coarse grinding and fine grinding from the viewpoint of improving the grinding efficiency, such as the uniformity of particle size, and reducing the grinding time.

In the grinding process, the young barley leaves are ground by using any coarse grinding equipment or apparatus commonly used by those skilled in the art, such as a cutter, a slicer, or a dicer, for example, until the long diameter of the young barley leaves becomes about 20 mm or less, preferably about 0.1-10 mm. The young barley leaves may also be coarsely ground manually, such as grinding by finely chopping dried young barley leaves with a knife. Multiple grinding processes may be performed, such as performing a fine grinding process to grind the leaves more finely after performing the coarse grinding process. In the case of performing a fine grinding process, the young barley leaves are finely ground by using any fine grinding equipment or apparatus normally used by those skilled in the art, such as a crusher, a mill, a blender, or a stone mill. In the case where grinding is performed multiple times, the time from harvesting to grinding of the young barley leaves refers to the time required from harvesting the young barley leaves to completing the first grinding process.

### [C. Vivid Green Color]

In the invention, the vivid green color means that the value of a* in the CIE L*a*b* color system is −2 or less, and the value of L* is 50 or more. The CIE L*a*b* color system is a color system widely used for measuring color differences for color management. The values of a* and b* indicate the strength of the color tone, where the value of a* represents the red-green axis and the value of b* represents the yellow-blue axis. The value of L* represents brightness (lightness). The more negative the value of a*, the stronger the green color, and the more positive the value of L*, the brighter the color becomes. Conventional young barley leaf powder exhibits a value of a* that is about −1 to −2 and a value of L* that is less than 50, resulting in a weak and dark green color. Meanwhile, the young barley leaf powder of the invention has a value of a* that is −2 or less and a value of L* that is 50 or more, thus presenting a strong and bright green color (vivid green color). Due to such visual properties, the young barley leaf powder of the invention can create a healthy image and has the effect of being more appealing to people.

Although there is no particular limitation in the invention on the value of a* in the CIE L*a*b* color system for the young barley leaf powder as long as the value of a* is −2 or less, from the point of strengthening the green color and further enhancing the healthy image, the value of a* is more preferable to be −3 or less, even more preferable to be −4 or less, particularly preferable to be −4.5 or less, and most preferable to be −5 or less. Although there is no particular limitation in the invention on the lower limit of the value of a*, from the point of being more appealing to people, the lower limit is preferable to be −20 or more, more preferable to be −18 or more, particularly preferable to be −15 or more, and most preferable to be −12 or more.

Although there is no particular limitation in the invention if the value of L* in the CIE L*a*b* color system for the young barley leaf powder is 50 or more, from the point of increasing the brightness to improving the healthy image, the value of L* is more preferable to be 51 or more, even more preferable to be 53 or more, particularly preferable to be 54 or more, and most preferable to be 55 or more. Although there is no particular limitation in the invention on the upper limit of the value of L*, from the point of being more appealing to people, the upper limit is preferable to be 80 or less, more preferable to be 75 or less, particularly preferable to be 70 or less, and most preferable to be 65 or less.

The values of a* and L* of the young barley leaf powder in the CIE L*a*b* color system can be measured by using a colorimeter. Specifically, the values of a* and L* of the young barley leaf powder can be measured by using a colorimeter “Color Reader CR20” (manufactured by Konica Minolta).

### [D. Food or Beverage Containing Young Barley Leaf Powder]

An aspect of the invention is a food or beverage containing the young barley leaf powder (hereinafter also referred to as “the food or beverage of the invention”). The food or beverage of the invention may contain only the young barley leaf powder, or can include other food ingredients commonly used in addition to young barley leaf powder. As such ingredients, various excipients, binders, glazing agents, lubricants, stabilizers, diluents, bulking agents, thickeners, emulsifiers, antioxidants, pH adjusters, colorants, flavoring agents, and additives can be selected as appropriate.

As the forms of the food of the invention, examples may include tablet, capsule, powder, granule, liquid, paste, and stick forms. Among the dosage forms, from the viewpoint of manufacturability and case of intake, powder, granule, and tablet forms are preferable. The expression “granule” refers to a granulated product. In the case where the form of the food of the invention is powder-like or granular, such form has excellent properties in terms of manufacturability, such as good flowability and ease of filling into individual packages. Specific examples of the food of the invention include, for example, tablets, soft capsules, and hard capsules containing young barley leaf powder.

Examples of the form of the beverage of the invention include liquid or powdered beverage. The expression “powdered beverage” refers to a powder-like processed food product intended for drinking by mixing with liquids such as water, hot water, milk, or soy milk. The form of the beverage of the invention can be either, but since the young barley leaf powder of the invention has the property of being easily dispersed when suspended in water, it is particularly preferable to be in the form of a powdered beverage. The form of powdered beverage is also preferable in terms of being lightweight and easy to carry, as well as easy to store. Specific examples of the beverage of the invention may include, for example, green juice, vegetable juice, smoothies, and powdered beverages made by powdering the drinks.

As described above, the food or beverage of the invention may contain only the young barley leaf powder, or can include other food ingredients commonly used in addition to young barley leaf powder. In the case where the food or beverage of the invention contains food ingredients other than young barley leaf powder, there is no particular restriction on the content of the young barley leaf powder in the food or beverage. However, from the viewpoint of consuming a large amount of nutrition components from the young barley leaf powder, for example, on a dry mass basis of the entire food or beverage, 0.1 weight % or more is preferable, 0.5 weight % or more is more preferable, 1 weight % or more is further preferable, 10 weight % or more is even more preferable, and 20 weight % or more is particularly preferable.

In the food or beverage of the invention, the daily intake amount of the young barley leaves is not particularly limited, but for example, the daily intake amount may be 0.01 g to 100 g, preferably 0.05 g to 70 g, more preferably 0.5 g to 50 g, and further preferably 1 g to 30 g. Likewise, in the food or beverage of the invention, the intake amount of the young barley leaves per serving is not particularly limited, but for example, the intake amount of the young barley leaves per serving may be 0.01 g to 30 g, preferably 0.05 g to 20 g, more preferably 0.1 g to 10 g, and further preferably 0.3 g to 7 g.

### EXAMPLES

The invention is described in more detail below with examples, but the invention is not limited to the examples and can take various forms as long as it can solve the problems of the invention.

### [A. Production of Young Barley Leaf Powder]

### Example 1

The aerial parts (leaves and stems) of barley with a height of about 30 cm were harvested in the field. Within 20 hours after harvesting, a pretreatment was performed by washing with water to remove adhered mud, etc., and cutting the aerial parts into pieces of about 5-10 cm in size. A blanching process was performed on the pretreated young barley leaves only once for 120 seconds with hot water at 90° C.-100° C., and then cooled with cold water. Subsequently, the obtained young barley leaves were dried in a dryer at 80° C.-130° C. for 20 minutes to 180 minutes until the moisture content became 5 weight % or less. The dried young barley leaves were ground to a size of about 1 mm to obtain the young barley leaf powder of Example 1. The time required from harvesting the young barley leaves to completing the grinding process was within 24 hours.

### Comparative Example 1

The aerial parts (leaves and stems) of barley with a height of about 30 cm were harvested in the field. After harvesting, the young barley leaves were transported to a research facility over the course of 1 day and stored at room temperature of 10° C. for 5 days. Then, a pretreatment was performed by washing the young barley leaves with water to remove adhered mud, etc., and cutting the aerial parts into pieces of about 5-10 cm in size. A blanching process was performed on the pretreated young barley leaves only once for 120 seconds with hot water at 90° C.-100° C., and then cooled with cold water. Subsequently, the obtained young barley leaves were dried in a dryer at 80° C.-130° C. for 20 minutes to 180 minutes until the moisture content became 5 weight % or less. The dried young barley leaves were ground to a size of about 1 mm to obtain the young barley leaf powder of Comparative Example 1. The time required from harvesting the young barley leaves to completing the grinding process was about 7 days.

### [B. Evaluation of Color (Green) and Brightness]

For the young barley leaf powder of the Example and Comparative Example, the values of a* and L* were measured by using a color meter “Color Reader CR20” (manufactured by Konica Minolta) under the following conditions. The measurement results are shown in Table 1.
Viewing angle: 10° field of view
Light source: D65

TABLE 1

| | Value of a* | Value of L* |
|---|---|---|
| Example 1 | −5.3 | 55.4 |
| Comparative | −1.4 | 48.7 |
| Example 1 | | |

As clearly shown according to the results in Table 1, the young barley leaf powder of Example 1 has a lower value of a* and a higher value of L* than the values of the young barley leaf powder of Comparative Example 1. From this, it is found that by performing the process from harvesting to powder within 24 hours, a young barley leaf powder with a vivid green color that is strongly green and has a bright tone can be obtained.

### [C. Sensory Evaluation]

A sensory evaluation was conducted with a panel of 5 members engaged in the development of health foods. Specifically, the 5 panelists were asked to choose, between the young barley leave powders of Example 1 and Comparative Example 1, the young barley leave powder corresponding to the following items.
Item 1: More visually appealing
Item 2: More appetite-stimulating
Item 3: More desirable to consume

As a result of the test, all subjects selected the young barley leaf powder of Example 1 in all items. From this, it is clear that by performing the process from harvesting to grinding within 24 hours, a young barley leaf powder that is visually appealing and preferred by people can be obtained.

### [D. Food Containing Young Barley Leaf Powder]

The young barley leaf powder of Example 4 was further ground to obtain a young barley leaf fine powder with a median diameter of 20 μm (Example 2). The young barley leaf fine powder of Example 2 was mixed with the following components to produce 100 g of powdered beverage. The obtained powdered beverage presented a vivid green color and had a desirable appearance.

| | | |
|---|---|---|
| Young barley leaf fine powder (Example 2) | 80 | mass % |
| Indigestible dextrin | 15 | mass % |
| Erythritol | 5 | mass % |
| Total | 100 | mass % |

### INDUSTRIAL UTILITY

The young barley leaf powder of the invention presents a vivid green color and has a desirable appearance, which increases appetite. Therefore, it can be used as a food or beverage such as a powdered drink, and has high industrial utility.

What is claimed is:

1. A young barley leaf powder, wherein, in a CIE L*a*b* color system, a value of a* is −2 or less, and a value of L* is 50 or more.

2. A method for producing the young barley leaf powder as claimed in claim 1, the method comprising:
(1) a process of harvesting young barley leaves;
(2) a process of performing a blanching process on the young barley leaves that are harvested with hot water;
(3) a process of drying the young barley leaves on which the blanching process is performed; and
(4) a process of grinding the young barley leaves that are dried,
wherein the processes from (1) to (4) are performed within 24 hours.

3. An oral composition, containing the young barley leaf powder as claimed in claim 1.
